(19) United States
(12) Patent Application Publication
(10) Pub. No.: US 2026/0195146 A1
(43) Pub. Date: Jul. 9, 2026

(54) FACILITATED USER ACCESS TO AN ONLINE CANCELLATION OPTION OBSCURED BY HOSTILE ARCHITECTURE DESIGN

(71) Applicant: INTERNATIONAL BUSINESS MACHINES CORPORATION, ARMONK, NY (US)

(72) Inventors: Heather Nicole Polgrean, Lagrangeville, NY (US); Jessica Nahulan, Vaughan (CA); John S. Werner, Fishkill, NY (US); Jeremy R. Fox, Georgetown, TX (US); Tyler HANSEN, TUCSON, AZ (US)

(21) Appl. No.: 19/012,044

(22) Filed: Jan. 7, 2025

(51) Int. Cl. G06F 9/451; G06Q 30/0601

(52) U.S. Cl. CPC G06F 9/451; G06Q 30/0635

(57) ABSTRACT

An approach is provided for facilitating user access to an obscured online cancellation option. By using natural language processing (NLP) and learned patterns of order systems that employ hostile architecture designs, it is determined that cancellation option(s) that cancel order(s) are obscured by hostile architecture design(s) employed by online platform(s). The order(s) specify service(s) ordered by a user. Cancellation selection(s) are presented in a user interface to provide the user with a direct access to an activation of the cancellation option(s). The direct access provides a user experience that avoids the hostile architecture design(s).

### BACKGROUND

The present invention relates to user interactions with online platforms, and more particularly to simplifying user access to obscured options on online platforms.

### SUMMARY

In one embodiment, the present invention provides a computer-implemented method. The method includes determining, by using natural language processing (NLP) and learned patterns of order systems that employ hostile architecture designs, that one or more cancellation options that cancel one or more orders, respectively, are obscured by one or more hostile architecture designs employed by one or more online platforms. The one or more orders specify one or more services ordered by a user. The method further includes presenting in a user interface one or more cancellation selections that provide the user with a direct access to an activation of the one or more cancellation options. The direct access provides a user experience that avoids the one or more hostile architecture designs.

A computer system and a computer program product corresponding to the above-summarized computer-implemented method are also described herein.

### BRIEF DESCRIPTION OF THE DRAWINGS

FIG. 1 is a block diagram of a system for facilitated user access to an obscured online cancellation option, in accordance with embodiments of the present invention.

FIG. 2 is a block diagram of modules included in code included in the system of FIG. 1, in accordance with embodiments of the present invention.

FIG. 3 is a flowchart of a process of providing facilitated user access to an obscured online cancellation option in response to a detected user request for an order cancellation, where operations of the flowchart are performed by one or more modules in FIG. 2, in accordance with embodiments of the present invention.

FIG. 4 is a flowchart of a process of providing facilitated user access to recommended online cancellation option(s), where operations of the flowchart are performed by modules in FIG. 2, in accordance with embodiments of the present invention.

FIG. 5 is a block diagram of a system that performs the operations in the flowchart of FIG. 4, in accordance with embodiments of the present invention.

FIG. 6 is an example of using the process of FIG. 4 to process cancellations of services, in accordance with embodiments of the present invention.

### DETAILED DESCRIPTION

### Overview

Known e-commerce platforms are increasingly using hostile architecture designs (i.e., hostile user experience (UX) designs) to manipulate user behavior, particularly in the context of order cancellations. The hostile architecture designs intentionally obscure cancellation options, thereby leading to inadvertent continuation of services and associated end user frustration. As used herein, obscuring a cancellation option means hiding the cancellation option (i.e., making it difficult for an end user to locate the cancellation option) and/or complicating the activation of the cancellation option (i.e., making it difficult for an end user to enact the cancellation option due to a complexity of the process required to enact the cancellation option), through the use of intentionally selected architecture designs. Hostile architecture designs include, for example, multiple confirmation screens, repeated confirmation prompts, text links hidden by the use of small and/or low contrast text, misleading language on buttons, non-standard locations for buttons, and distracting elements.

This tactic of obscuring cancellation options is used in many industries, including, but not limited to, media streaming, software as a service (SaaS), and various online ordering systems, where users frequently face hurdles when attempting to disengage. The users affected by obscured cancellation options are burdened with undue costs and/or inadvertently accumulated orders for items that the users seldom use or have forgotten about. Exacerbating the problem of intentionally obscured cancellation options is the user being required to attempt to locate various cancellation options via separate, unfriendly user interfaces, thereby causing financial inefficiencies for users and eroding trust in digital service providers. Industries that rely on order models are particularly prone to the aforementioned issues, as the obscured cancellation options can provide a short-term advantage of a temporary barrier to revenue loss, while risking a long-term disadvantage of impeding user satisfaction and loyalty.

Websites that deploy hostile UX design tactics to obscure cancellation processes undermine user autonomy, pose ethical issues, and potentially contravene consumer protection laws.

Embodiments of the present invention address the aforementioned unique challenges by (i) automatically identifying online options for cancelling e-commerce orders, where the options are intentionally obscured by hostile architecture design employed by service providers, (ii) determining which of the identified online cancellation options are recommended for activation based on machine learning performed to analyze and assess usage patterns, (iii) providing a centralized user interface that presents selections that activate the recommended online cancellation options, and (iv) in response to a user selection of a recommended online cancellation option via the centralized user interface, activating the selected option to cancel the associated e-commerce order in a streamlined manner for the user, which allows the user to avoid difficulties with finding and enacting the cancellation option, where the difficulties are provided by the hostile architecture design.

In one embodiment, the intelligent, user-centric order cancellation approach disclosed herein integrates with various service platforms to identify and execute cancellation processes, thereby ensuring that user intent for order termination is executed promptly and efficiently within various commerce transactions.

In one embodiment, the intelligent, user-centric order cancellation approach disclosed herein addresses the complexity and obfuscation users face when trying to cancel online orders by providing an automated, user-friendly system that simplifies the cancellation process via natural language processing (NLP). The cancellation simplification system disclosed herein navigates through the hostile architecture design tactics without burdening users, thereby effectively aiding the users in managing and terminating undesired orders or items.

In one embodiment, the intelligent, user-centric order cancellation approach disclosed herein simplifies and enhances user interactions with e-commerce platforms, and facilitates consumer transparency and empowerment, thereby allowing users to reclaim control over their digital engagements, especially in managing online orders effectively and asserting their rights within the digital economy.

In one embodiment, the intelligent, user-centric order cancellation approach disclosed herein includes an integrated authentication process that ensures secure access to users'order information, while maintaining privacy and data protection standards during order cancellations.

In one embodiment, the intelligent, user-centric order cancellation approach disclosed herein is implemented in a system that includes a feedback mechanism that refines a behavior analysis algorithm, thereby enhancing the system's accuracy and personalization over time as a result of order cancellations obscured via the aforementioned hostile architecture design.

In one embodiment, the intelligent, user-centric order cancellation approach disclosed herein initiates a user request for a service termination, which employs (i) a user interface to receive and authenticate service termination requests, (ii) a module to interpret and classify user interactions to determine service usage patterns, and (iii) a user feedback component to refine the service termination request based on user input and preferences.

In one embodiment, the intelligent, user-centric order cancellation approach disclosed herein includes a transactional execution module configured to process an authenticated order cancellation request by using (i) a decision-making algorithm to prioritize order cancellation requests based on learned user behavior, and (ii) an execution protocol to interface with third-party service databases to complete the order cancellation process.

In one embodiment, the intelligent, user-centric order cancellation approach disclosed herein includes an integrated learning system that adapts to user behavior and feedback. The integrated learning system generates and modifies recommendations for cancelling orders. Furthermore, the integrated learning system improves the accuracy of its order cancellation actions over time, employing a feedback loop to capture user response to recommended cancellations for continuous system enhancement.

### Computing Environment

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, computer-readable storage media (also called “mediums”) collectively included in a set of one, or more, storage devices, and that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

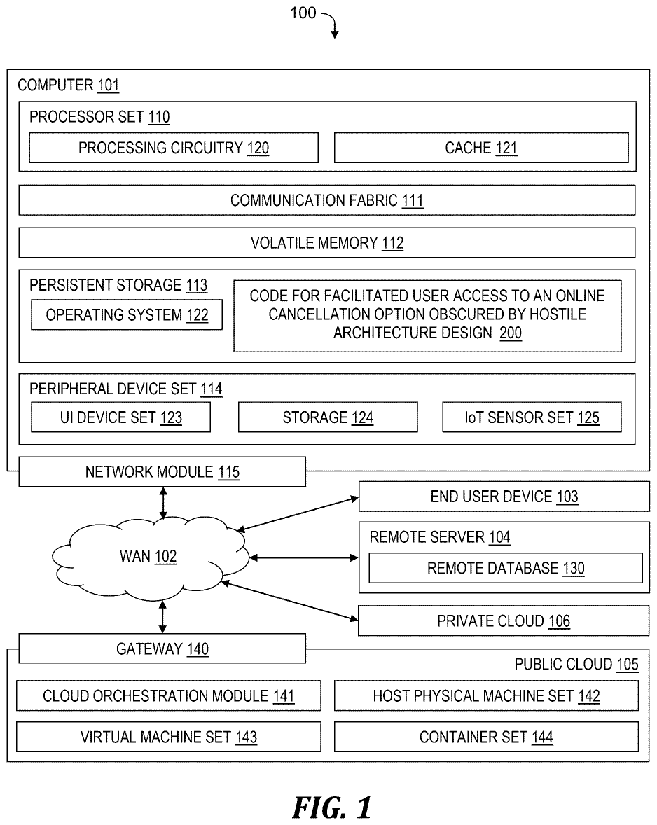

FIG. 1 is a block diagram of a system for facilitated user access to an obscured online cancellation option, in accordance with embodiments of the present invention. Computing environment 100 contains an example of an environment for the execution of at least some of the computer code involved in performing the inventive methods, such as code 200 for facilitated user access to an online cancellation option obscured by hostile architecture design. The aforementioned computer code is also referred to herein as computer-readable code, computer-readable program code, and machine readable code. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

### System and Process for Facilitated User Access to an Obscured Online Cancellation Option

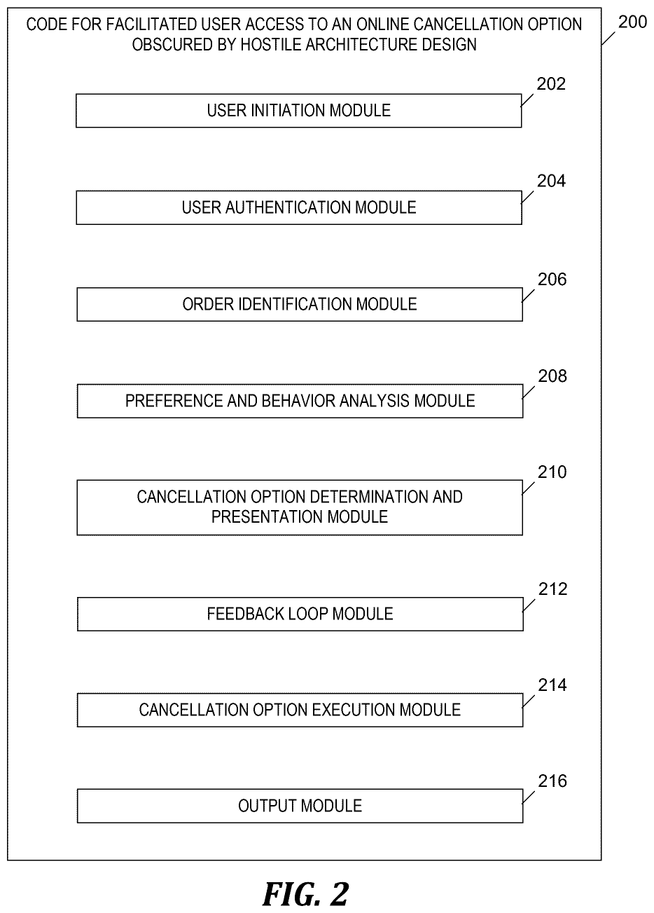

FIG. 2 is a block diagram of modules included in code included in the system of FIG. 1, in accordance with embodiments of the present invention. Code 200 includes a user initiation module 202, a user authentication module 204, an order identification module 206, a preference and behavior analysis module 208, a cancellation option determination and presentation module 210, a feedback loop module 212, a cancellation option execution module 214, and an output module 216.

User initiation module 202 is configured to perform an initiation process that includes generating and presenting a user initiation interface that receives a user log-in or selection to opt in to the novel process for facilitated user access to obscured online cancellation options. The user initiation interface incorporates a user-friendly design that enables easy navigation for a user to begin the user's cancellation request(s). The user interface design incorporates intuitive navigation pathways to ensure that the process of submitting a cancellation request is straightforward and accessible. Further, the user interface design utilizes human-computer interaction principles to reduce cognitive load and avoid user frustration, thereby preventing drop-offs at the initial stage.

User authentication module 204 is configured to prompt the user for authentication of the user through secure protocols to ensure security and data privacy. The authentication includes verifying the user's identity and occurs subsequent to completing the initiation by user initiation module 202. The authentication is necessary to secure user accounts and prevent unauthorized cancellations. In one embodiment, the authentication employs the OAuth 2.0 protocol for secure authorization, utilizing tokens instead of credentials to access data about a user's order. The authentication ensures that the process for facilitated user access to obscured online cancellation options adheres to best practices in user security and data privacy.

Order identification module 206 is configured to scan the user's associated accounts to identify active orders for commerce (e.g., active subscriptions) in response to receiving consent from the user for the scanning. The scanning of the user's accounts is performed after the authentication performed by user authentication module 204. In one embodiment, the scanning of the user's accounts is performed by an algorithm that parses and analyzes user data and distinguishes between active, pending, and past (i.e., stale) orders using pattern recognition and NLP to comprehend, for example, service order-related communications in the user's account. In one embodiment, order identification module 206 receives consent from the user to data being extracted from applications executed on the user's device, and in response to the consent being received, uses application programming interfaces (APIs) to extract data from other applications being executed on the user's device. These APIs can interact with each of the other applications individually or can interact with one or a selected subset of the applications that contain data about purchases (e.g., extracting purchase data from emails within the user's email app).

Preference and behavior analysis module 208 is configured to evaluate behavior of the user to determine the likelihood of and discern between ordered services that are intentionally active and other ordered services whose activation has been forgotten about and inadvertently retained by the user (i.e., services that have little or no value to the user). The behavior evaluation uses a machine learning algorithm to analyze and assess usage patterns and frequency of usage of the ordered services to determine which order(s) are no longer of value to the user. In one embodiment the machine learning algorithm used by the behavior evaluation is a decision tree classifier. In one embodiment, a user interaction monitoring module (not shown in FIG. 2) on the user's device monitors user interaction with other applications residing on the user's device and the preference and behavior analysis module 208 performs the machine learning algorithm on an application server (external to the user's device), thereby reducing data processing on the user's device. In another embodiment, the aforementioned machine learning algorithm is performed locally on the user's device.

Cancellation option determination and presentation module 210 is configured to detect obscured cancellation options within digital user interfaces associated with the ordered services. The detection of the obscured cancellation options includes using (i) an NLP module (not shown) configured to parse and interpret the layout and structure of user interfaces and (ii) a navigation module (not shown) that utilizes learned patterns of hostile architecture design tactics to locate, highlight, and simplify access to cancellation options without requiring manual user intervention. Cancellation option determination and presentation module 210 is configured to train machine learning models to recognize hostile architecture design patterns used to hide cancellation options. The patterns being recognized can include, for example, (i) small, low contrast text links hidden among other options, (ii) multiple confirmation screens or repeated prompts to deter users, and (iii) non-standard locations for cancellation buttons or misleading button labels (e.g., “Are you sure?” or “Proceed” without clearly indicating that the activation of the button leads to cancellation).

Cancellation option determination and presentation module 210 is also configured to present cancellation selections corresponding to the cancellation options, where the cancellation selections are presented to the user through an intuitive cancellation facilitation user interface. In one embodiment, the cancellation facilitation user interface highlights recommendations of cancellation option(s) for service(s) to be cancelled, where activation(s) of the service(s) associated with one or more of the recommended cancellation option(s) were identified as being inadvertently retained by preference and behavior analysis module 208. In one embodiment, cancellation option determination and presentation module 210 generates the cancellation facilitation user interface to include a prioritized list of options for cancelling orders that the system is designating as recommended candidates for cancellation.

Feedback loop module 212 is configured to receive user confirmations and/or corrections of the cancellation selections presented by (or the recommended cancellation options highlighted by) cancellation option determination and presentation module 210. Feedback loop module 212 uses the received confirmations and corrections as input to a feedback loop employed by the system providing the facilitated user access to the cancellation options obscured by hostile architecture design. The system uses the feedback loop to train and refine machine learning models continuously, thereby ensuring that the system evolves and adapts to changing user behavior and user preferences over time, which improves system accuracy and future recommendations of cancellation options. In one embodiment, feedback loop module 212 receives input from a user interaction monitoring module (not shown) and a user feedback module (not shown) on the user's device to continuously train the machine learning models and improve the future output recommendations of cancellation options.

Cancellation option execution module 214 is configured to, in response to a user selection of a cancellation selection presented in the cancellation facilitation user interface, process the cancellation request associated with the selected cancellation selection, where the processing is performed through a secure execution protocol and includes interfacing with third party service databases to complete the cancellation of the service. Following the completion of the cancellation of the service, feedback loop module 212 receives and uses user feedback to perform continuous improvement of the system, which includes employing reinforcement learning to adjust decision-making processes based on user interactions and preferences. In one embodiment, APIs connect to the application servers to automatically perform the complex process of cancellation by automatically navigating the pathway provided by the hostile architecture design, without requiring the user to navigate or otherwise be exposed to the hostile architecture design. The user experience for cancelling an order is a simplified process of selecting a cancellation selection presented in the cancellation facilitation user interface, which provides a direct access to the cancellation processing, and eliminates any user experience of redundant steps, obfuscated links, non-intuitive pathways, and/or any other elements of the hostile architecture design.

Output module 216 is configured to present in the cancellation facilitation user interface or in another user interface a final output that includes a list of the one or more orders that were successfully canceled by the processing of cancellation requests by cancellation option execution module 214. In one embodiment, the final output presented by output module 216 also includes updated user profile information, an updated status of the services associated with the user's orders, and recommendations for future management of subscriptions or other services.

In alternate embodiments, code 200 excludes one or more modules shown in FIG. 2, such as excluding preference and behavior analysis module 208, feedback loop module 212, and/or output module 216.

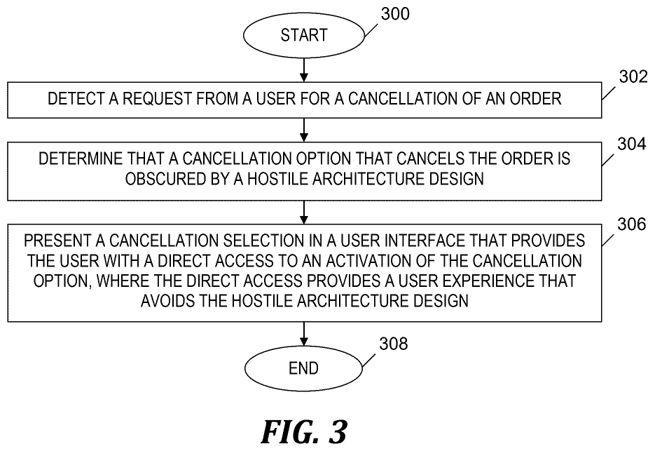

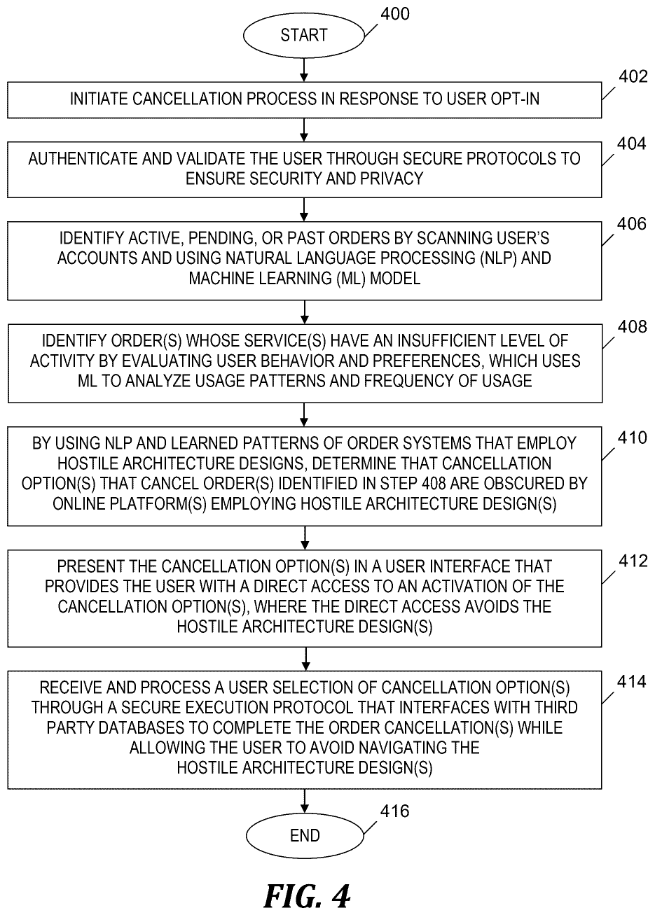

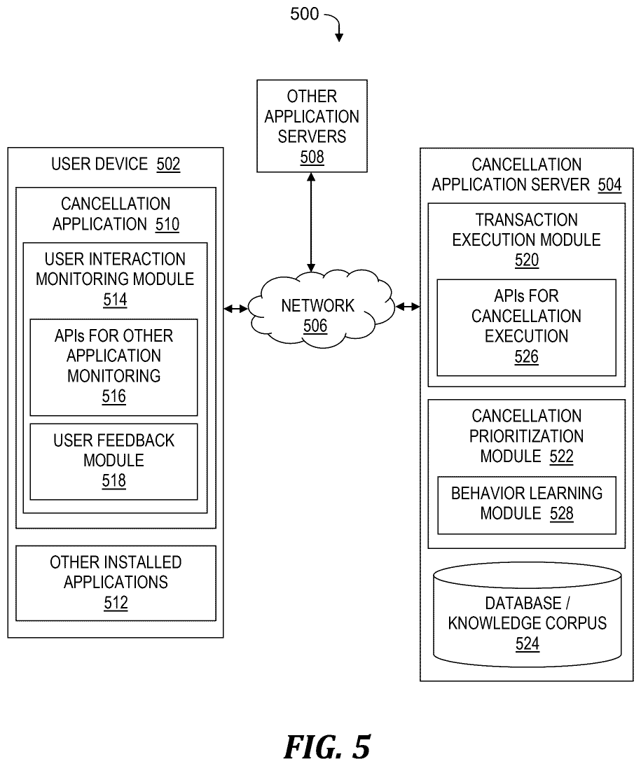

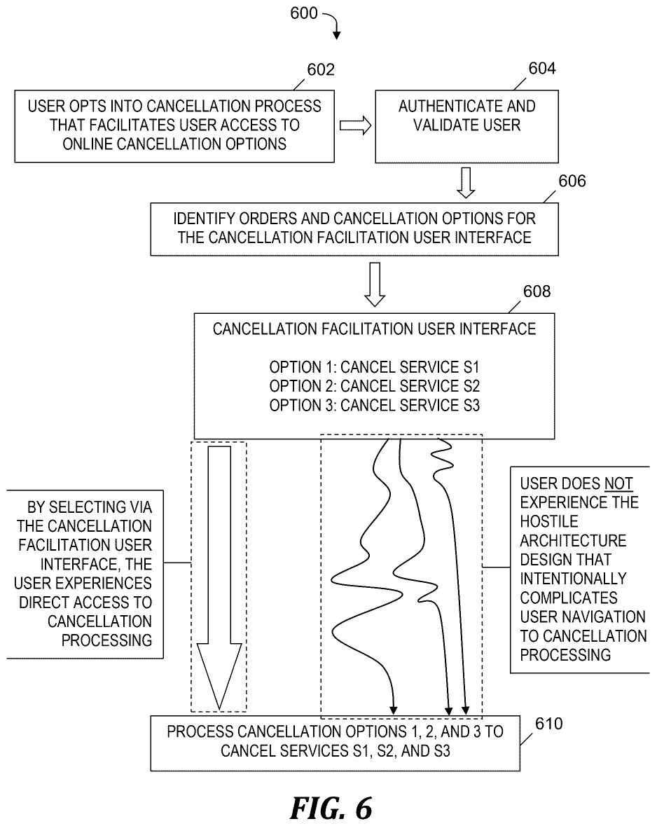

The functionality of the modules included in code 200 is described in more detail in the discussions presented below relative to FIG. 3, FIG. 4, FIG. 5, and FIG. 6.

FIG. 3 is a flowchart of a process of providing facilitated user access to an obscured online cancellation option in response to a detected user request for an order cancellation, where operations of the flowchart are performed by one or more modules in FIG. 2, in accordance with embodiments of the present invention. The process of FIG. 3 begins at a start node 300. In step 302, a user request detection module (included in code 200, but not shown in FIG. 2) detects a request from a user for a cancellation of an order for a service. Hereinafter, in the discussion of FIG. 3, the aforementioned order for the service is referred to simply as “the order.”

In step 304, cancellation option determination and presentation module 210 identifies a cancellation option that cancels the order and determines that the identified cancellation option is obscured by a hostile architecture design employed by an online platform. In one embodiment, cancellation option determination and presentation module 210 uses NLP and learned patterns of order systems that employ hostile architecture designs to make the determination in step 304 that the cancellation option that cancels the order is obscured by the hostile architecture design.

In one embodiment, the identification of the cancellation option in step 304 includes using NLP to scan the text on each web page to identify keywords and phrases that may be related to cancellation (e.g., “end subscription,” “manage account,” “stop service,” or “cancel”). In one embodiment, the identification of the cancellation option includes using NLP to interpret semantic clues (e.g., interpret words and phrases that imply cancellation without using the term directly) and syntactical patterns (e.g., confirmatory statements or passive language which often surround cancellation options).

In step 306, cancellation option determination and presentation module 210 presents a cancellation selection in a user interface, where the cancellation selection provides the user with a direct access to an activation of the cancellation option, and where the direct access provides the user with a user experience that avoids the hostile architecture design that obscures the cancellation option.

Following step 306, the process of FIG. 3 ends at an end node 308.

FIG. 4 is a flowchart of a process of providing facilitated user access to recommended obscured online cancellation option(s), where operations of the flowchart are performed by modules in FIG. 2, in accordance with embodiments of the present invention. The process of FIG. 4 begins at a start node 400. Prior to step 402, the system providing a cancellation process that includes the facilitated user access to online cancellation options obscured by hostile architecture design receives a user log-in or user opt in to the cancellation process. In step 402, user initiation module 202 initiates the cancellation process in response to the user log in or opt in.

In step 404, user authentication module 204 authenticates and validates the user through secure execution protocols to ensure data security and data privacy. Step 404 includes authenticating the user's identity and authorizing the cancellation actions across various third party databases.

In step 406, order identification module 206 identifies and distinguishes between active, pending, and past orders of the user by scanning the user's accounts and using NLP and a machine learning model.

In step 408, preference and behavior analysis module 208 identifies order(s) specifying service(s) that have an insufficient level of activity (i.e., a measure of activity that is less than a predetermined threshold measure of activity) by evaluating user behavior and preferences, which uses machine learning to analyze and assess usage patterns and frequency of usage of services ordered by the user. In one embodiment, the aforementioned level of activity is a measure of a frequency of usage of a service.

In step 410, cancellation option determination and presentation module 210 identifies cancellation option(s) that cancel the order(s) identified in step 408, and determines that the identified cancellation option(s) are obscured by hostile architecture design(s) employed by online platform(s) that manage the order(s). In one embodiment, the identification of the cancellation option(s) includes using NLP to scan the text on each web page to identify keywords and phrases that may be related to cancellation (e.g., “end subscription,” “manage account,” “stop service,” or “cancel”). In one embodiment, the identification of the cancellation option(s) includes using NLP to interpret semantic clues (e.g., interpret words and phrases that imply cancellation without using the term directly) and syntactical patterns (e.g., confirmatory statements or passive language which often surround cancellation options). In one embodiment, step 410 includes determining cancellation option(s) that cancel the aforementioned identified order(s) that specify service(s) that have the insufficient level of activity.

In step 412, cancellation option determination and presentation module 210 presents the cancellation option(s) as selection(s) in a cancellation facilitation user interface that provides the user with a direct access to an activation of the cancellation option(s), where the direct access allows the user to completely avoid the hostile architecture design(s). In one embodiment, the cancellation facilitation user interface is a centralized, easy-to-navigate interface that displays actionable selections of cancellation options and that integrates with third party service platforms via secure APIs to retrieve, display, and process cancellation options for multiple subscriptions, providing a single unified access point for managing cancellations across different services.

In step 414, cancellation option execution module 214 receives and processes a user selection of cancellation option(s) in the cancellation facilitation user interface. The processing of the user selection is performed through a secure execution protocol that interfaces with third party databases to complete the cancellation of service(s) associated with the selected cancellation option(s) while allowing the user to avoid navigating through the hostile architecture design(s). In one embodiment, the system providing the cancellation process automates clicks and interactions to navigate through nested menus or layers of the interface for processing the cancellation. By using this automated navigation, the user is not required to manually search for the cancellation option, thereby avoiding frustrations that users experience when performing the conventional multi-step cancellations. In one embodiment, the system follows “click paths” by simulating user actions to reach hidden buttons and analyzing each interface update or screen change to determine whether its automated navigation is moving closer to a cancellation confirmation page.

Following step 414, the process of FIG. 4 ends at an end node 416.

In one embodiment, step 412 includes cancellation option determination and presentation module 210 presenting the cancellation option(s) as prioritized recommendations in the user interface. Subsequent to step 412 and prior to step 414, feedback loop module 212 receives from the user a confirmation or correction of each recommendation and inputs the confirmation(s) and correction(s) into a feedback loop that refines the machine learning model to improve the accuracy of future recommended cancellation options. In the embodiment described in this paragraph, step 414 includes cancellation option execution module 214 receiving and processing a user selection of cancellation option(s) for which user confirmation(s) are received, as described above. A reinforcement learning model is integrated within the cancellation system that implements the process of FIG. 4 to refine the detection and navigation of cancellation paths based on user confirmations, thereby allowing the system to respond adaptively to new and modified hostile architecture design tactics.

In one embodiment, subsequent to step 414, feedback loop module 212 incorporates user feedback for continuous improvement of the system that provides the facilitated user access to online cancellation options obscured by hostile architecture design, where the improvement employs reinforcement learning to adjust decision-making processes based on user interactions and preferences. The aforementioned incorporated user feedback includes the user confirming whether the system correctly found a cancellation option and correctly executed the associated cancellation. The system uses this user feedback to improve a database that stores hostile design patterns, which improves the system's adaptation to new tactics as interfaces evolve. The user feedback also includes information about repeated interactions across different platforms, which is used by the system to improve the accuracy of detecting and navigating hostile architecture designs, thereby ensuring effective identification of obscured cancellation options as hostile architecture designs change over time.

In one embodiment, subsequent to step 414, output module 216 generates and presents a final output that includes a list of successful order cancellation(s) performed by step 414. In one embodiment, output module 216 presents the final output to also include updated user profile and subscription status, and recommendations for future subscription management.

In one embodiment, subsequent to a cancellation of a service in step 414, a re-order module (not shown in FIG. 2) re-orders the canceled service, where the cancellation and re-ordering are based on seasonal or periodic usage patterns to enable an overall cost savings, and without requiring the user to re-order the service manually. In one embodiment, the cancellation and re-ordering of the service are based on a determination of a usage pattern for the service that includes the user utilizing the service during a recurring first time period and the user not utilizing the service during a recurring second time period, where the first and second time periods are non-overlapping time periods. In one embodiment, the service is active for the user for a first occurrence of the first time period, the cancellation of the service in step 414 cancels the order for the service via the user interface so that the service is canceled during at least a portion of a first occurrence of the second time period, and after the cancellation of the order, the re-order module re-orders the service for the user via the user interface so that the service is activated for the user during at least a portion of a second occurrence of the first time period which is subsequent to the aforementioned first occurrence of the second time period.

For example, a user typically does not use a subscription service during the summer months of June, July, and August, but uses the subscription service in the months of September through May. In this example, cancellation option execution module 214 cancels the subscription service for June, July, and August, and the re-order module re-activates the subscription service in September, when the user is expected to start using the service again. This cancellation of the subscription service for the summer months allows the user to save three months of subscription costs each year without requiring the user to directly manage the complexities of cancelling and re-activating the subscription service.

In another embodiment, the preference and behavior analysis module 208 collects and analyzes historical data about the user and/or user-inputted schedules, such as the user's calendar entry dates that indicate the user's departure and return dates for an upcoming travel itinerary, to identify a first time period (i.e., a future time period; e.g., a time period between the date of departure and the date of return for the user's upcoming travel itinerary) during which the user is not likely to use the subscription service. Cancellation option execution module 214 cancels the subscription service during that identified future time period, and a re-order module (not shown) re-activates the subscription service for a second time period (i.e., another time period subsequent to the first time period) during which the user is determined to be likely to use the subscription service based on the collected historical data and/or user-inputted schedules.

FIG. 5 is a block diagram of a system 500 that performs the operations in the flowchart of FIG. 4, in accordance with embodiments of the present invention. System 500 includes a user device 502 and a cancellation application server 504, which are in communication with each other via a network 506. System 500 also includes other application servers 508.

User device 508 includes a cancellation application 510 and other installed applications 512. Cancellation application 510 includes a user interaction monitoring module 514, which includes APIs for other application monitoring 516 and a user feedback module 518.

Cancellation application server 504 includes a transaction execution module 520, a cancellation prioritization module 522, and a database/knowledge corpus 524. Transaction execution module 520 includes APIs for cancellation execution 526. Cancellation prioritization module 522 includes a behavior learning module 528.

Cancellation application server 504 performs the initiation of the cancellation process in step 402 and the authentication and validation of the user in step 404. In one embodiment, user interaction monitoring module 514 identifies the active orders of the user in step 406 by using APIs for other application monitoring 516 to scan user accounts in other installed applications 512. In one embodiment, APIs for other application monitoring 516 employs secure RESTful APIs to interact with third party order services for data retrieval from other application servers 508. The secure RESTful APIs conform to OpenAPI specifications, thereby ensuring interoperability and ease of integration with a range of services.

Cancellation prioritization module 522 performs the identification of the order(s) whose service(s) have an insufficient level of activity (as described above in the discussion of FIG. 4) by using behavior learning module 528 (which includes preference and behavior analysis module 208) to evaluate user behavior and preferences. The evaluation of the user behavior uses machine learning to analyze and assess usage patterns and frequency of usage. In one embodiment, behavior learning module 528 employs a decision tree classifier to analyze user behavior to identify orders whose services are likely to be unnecessarily active. The utilization of decision trees offers a balance between simplicity and predictive power.

Cancellation prioritization module 522 performs the determination in step 410 that cancellation option(s) that cancel the order(s) identified in step 408 are obscured by hostile architecture design(s), and further performs the presentation of the cancellation option(s) as selection(s) in a user interface in step 412. To make the determination in step 410, cancellation prioritization module 522 utilizes machine learning models that are trained on data in database/knowledge corpus 524, which includes examples of hostile architecture design tactics. By comparing the layout and content of a current page with known hostile patterns included in database/knowledge corpus 524, cancellation prioritization module 522 identifies the cancellation options that are obscured and stores successful navigation routes to the cancellation options in database/knowledge corpus 524. System 500 continuously updates database/knowledge corpus 524 with user input and new examples of obscured cancellation options, thereby facilitating system 500 with remaining adept at interpreting challenging interfaces and providing users with direct access to cancellation options.

User feedback module 518 includes feedback loop module 212 and performs the receipt of the user confirmation or correction of each cancellation option presented in step 412. In one embodiment, user feedback module 518 implements a feedback loop using reinforcement learning to adjust the decision process based on the user-provided confirmations and corrections of the recommendations.

Transaction execution module 520 includes cancellation option execution module 214 and performs the processing in step 414 of a user selection of a cancellation option presented in the user interface in step 412. Transaction execution module 520 uses APIs for cancellation execution 526 to process cancellation requests through a secure execution protocol and by interfacing with third party databases managed by other application servers 508.

In one embodiment, system 500 adheres to ISO/IEC 27001 standard for information security management, ensuring that user data is handled securely. ISO is the abbreviation for International Organization for Standardization and IEC is the abbreviation for International Electrotechnical Commission. Furthermore, system 500 implements OAuth 2.0 standards for secure authorization and uses the Hypertext Transfer Protocol Secure (HTTPS) for all data transmissions to preserve integrity and confidentiality.

System 500 can enhance customer satisfaction and retention for cloud services by providing a transparent and user-friendly order management interface. By enabling customers to easily manage or cancel orders, system 500 fosters trust and loyalty. Further, by implementing system 500 across order-based service offerings, operational efficiencies can be achieved. By using system 500 to identify services being underutilized by an organization's customers, the organization can use system 500 to proactively suggest adjustments or service cancellations to their customers.

### EXAMPLE

FIG. 6 is an example 600 of using the process of FIG. 4 to process cancellations of services, in accordance with embodiments of the present invention. In step 602, the user opts into the novel cancellation process that facilitates user access to online cancellation options obscured by hostile architecture design. In one embodiment, step 402 is performed in response to step 602.

In step 604, user authentication module 204 authenticates and validates the user. In one embodiment, step 604 is included in step 404.

In step 606, order identification module 206 identifies active orders by scanning the user's accounts and preference and behavior analysis module 208 further identifies which of the services associated with those orders have an insufficient level of activity (i.e., a level of activity that is less than a predetermined threshold level of activity). Step 606 also includes cancellation option determination and presentation module 210 determining which of the cancellation options that cancel the services of the identified orders are obscured by hostile architecture designs.

Cancellation option determination and presentation module 210 identifies services S1, S2, and S3 as having insufficient levels of activity and as being associated with cancellation options that are obscured by hostile architecture designs. Because services S1, S2, and S3 are identified as mentioned above, cancellation option determination and presentation module 210 presents in step 412 a cancellation facilitation user interface 608, which includes options 1, 2, and 3 for cancelling the identified services S1, S2, and S3, respectively. In one embodiment, cancellation facilitation user interface 608 is presented on a display on user device 502.

The user selects options 1, 2, and 3 in cancellation facilitation user interface 608, and in response to the user selection, the user experiences a direct access to the processing of cancellation options 1, 2, and 3, which cancels services S1, S2, and S3 in step 510610 In one embodiment, step 610 is included in step 414. By having the direct access to the processing of the cancellations via the user selection of options in the cancellation facilitation user interface 608, the user does not experience the hostile architecture design that intentionally complicates conventional user navigation to the cancellation processing, where the conventional user navigation does not use the process of FIG. 3, the process of FIG. 4, or system 500.

The descriptions of the various embodiments of the present invention have been presented herein for purposes of illustration but are not intended to be exhaustive or limited to the embodiments disclosed. Many modifications and variations will be apparent to those or ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
determining, by using natural language processing (NLP) and learned patterns of order systems that employ hostile architecture designs, that one or more cancellation options that cancel one or more orders, respectively, are obscured by one or more hostile architecture designs employed by one or more online platforms, the one or more orders specifying one or more services ordered by a user; and
presenting in a user interface one or more cancellation selections that provide the user with a direct access to an activation of the one or more cancellation options, wherein the direct access provides a user experience that avoids the one or more hostile architecture designs.

2. The method of claim 1, further comprising:
identifying information about orders by scanning accounts of the user and identifying which of the orders are active orders, pending orders, or past orders, wherein the scanning uses NLP, pattern recognition, and machine learning, and includes analyzing user data and interpreting communications related to the orders, and wherein the orders whose information is identified include the one or more orders that specify the one or more services ordered by the user.

3. The method of claim 2, further comprising:
receiving from the user an indication of consent to an extraction of data from applications being executed on a device of the user and which include data about purchases made by the user; and
in response to the received consent, extracting the data about purchases from the applications by using application programming interfaces (APIs) that interact with the applications, wherein the identifying which of the orders are the active orders, the pending orders, or the past orders is based on the extracted data.

4. The method of claim 1, further comprising:
receiving a selection made by the user of a cancellation selection that cancels an order, wherein the cancellation selection is included in the one or more cancellation selections presented in the user interface, and wherein the order is included in the one or more orders; and
in response to the receiving the selection, canceling the order by performing a secure access to information about the order using an integrated authentication process and a secure execution protocol, wherein the secure access includes interfacing with a third-party service database, and wherein the canceling includes maintaining privacy and data protection standards.

5. The method of claim 1, further comprising:
identifying the one or more orders by determining that the one or more services specified by the one or more orders have one or more levels of activity, respectively, wherein each level of activity is less than a threshold level of activity based on a machine learning (ML) model analyzing one or more patterns of usage and frequencies of usage of the one or more services by the user;
presenting in the user interface the one or more cancellation selections as one or more recommendations to the user for canceling the one or more orders, respectively, the one or more recommendations being based on each of the one or more levels of activity of the one or more services being less than the threshold level of activity;
receiving, via the user interface, a correction or a confirmation made by the user of a recommendation included in the one or more recommendations;
refining the ML model by using a user feedback loop that employs reinforcement learning based on the correction or the confirmation; and
based on the refined ML model, generating and presenting improved recommendations to the user for canceling subsequent orders.

6. The method of claim 5, wherein the identifying the one or more orders includes evaluating one or more behaviors of the user to determine a likelihood of a given order being intentionally active or inadvertently retained by the user by assessing usage patterns and a frequency of usage for the given order by using a decision tree classifier.

7. The method of claim 5, further comprising:
determining a pattern of usage of a service by the user that includes the user utilizing the service during a recurring first time period and the user not utilizing the service during a recurring second time period, wherein the identifying the one or more orders includes identifying an order for the service based on the pattern of usage;
canceling the order for the service via the user interface so that the service is canceled for the user during at least a portion of an occurrence of the recurring second time period; and
subsequent to the canceling the order, re-ordering the service for the user via the user interface so that the service is activated for the user during at least a portion of a subsequent occurrence of the recurring first time period.

8. The method of claim 1, further comprising:
collecting data about the user including travel information that specifies dates of departure and return for a travel itinerary for the user; and
based on the travel information, presenting a recommendation in the user interface for cancelling an order for a service during a first time period and re-ordering the service for an activation of the service for the user during a second time period subsequent to the first time period, wherein the first time period is between the date of departure and the date of return for the travel itinerary for the user.

9. A computer system comprising:
a processor set;
one or more computer-readable storage media; and
program instructions stored on the one or more computer-readable storage media to cause the processor set to perform operations comprising:
determining, by using natural language processing (NLP) and learned patterns of order systems that employ hostile architecture designs, that one or more cancellation options that cancel one or more orders, respectively, are obscured by one or more hostile architecture designs employed by one or more online platforms, the one or more orders specifying one or more services ordered by a user; and
presenting in a user interface one or more cancellation selections that provide the user with a direct access to an activation of the one or more cancellation options, wherein the direct access provides a user experience that avoids the one or more hostile architecture designs.

10. The computer system of claim 9, wherein the operations further comprise:
identifying information about orders by scanning accounts of the user and identifying which of the orders are active orders, pending orders, or past orders, wherein the scanning uses NLP, pattern recognition, and machine learning, and includes analyzing user data and interpreting communications related to the orders, and wherein the orders whose information is identified include the one or more orders that specify the one or more services ordered by the user.

11. The computer system of claim 10, wherein the operations further comprise:
receiving from the user an indication of consent to an extraction of data from applications being executed on a device of the user and which include data about purchases made by the user; and
in response to the received consent, extracting the data about purchases from the applications by using application programming interfaces (APIs) that interact with the applications, wherein the identifying which of the orders are the active orders, the pending orders, or the past orders is based on the extracted data.

12. The computer system of claim 9, wherein the operations further comprise:
receiving a selection made by the user of a cancellation selection that cancels an order, wherein the cancellation selection is included in the one or more cancellation selections presented in the user interface, and wherein the order is included in the one or more orders; and
in response to the receiving the selection, canceling the order by performing a secure access to information about the order using an integrated authentication process and a secure execution protocol, wherein the secure access includes interfacing with a third-party service database, and wherein the canceling includes maintaining privacy and data protection standards.

13. The computer system of claim 9, wherein the operations further comprise:
identifying the one or more orders by determining that the one or more services specified by the one or more orders have one or more levels of activity, respectively, wherein each level of activity is less than a threshold level of activity based on a machine learning (ML) model analyzing one or more patterns of usage and frequencies of usage of the one or more services by the user;
presenting in the user interface the one or more cancellation selections as one or more recommendations to the user for canceling the one or more orders, respectively, the one or more recommendations being based on each of the one or more levels of activity of the one or more services being less than the threshold level of activity;
receiving, via the user interface, a correction or a confirmation made by the user of a recommendation included in the one or more recommendations;
refining the ML model by using a user feedback loop that employs reinforcement learning based on the correction or the confirmation; and
based on the refined ML model, generating and presenting improved recommendations to the user for canceling subsequent orders.

14. The computer system of claim 13, wherein the identifying the one or more orders includes evaluating one or more behaviors of the user to determine a likelihood of a given order being intentionally active or inadvertently retained by the user by assessing usage patterns and a frequency of usage for the given order by using a decision tree classifier.

15. A computer program product comprising:
one or more computer-readable storage media; and
program instructions stored on the one or more computer-readable storage media to perform operations comprising:
determining, by using natural language processing (NLP) and learned patterns of order systems that employ hostile architecture designs, that one or more cancellation options that cancel one or more orders, respectively, are obscured by one or more hostile architecture designs employed by one or more online platforms, the one or more orders specifying one or more services ordered by a user; and
presenting in a user interface one or more cancellation selections that provide the user with a direct access to an activation of the one or more cancellation options, wherein the direct access provides a user experience that avoids the one or more hostile architecture designs.

16. The computer program product of claim 15, wherein the operations further comprise:
identifying information about orders by scanning accounts of the user and identifying which of the orders are active orders, pending orders, or past orders, wherein the scanning uses NLP, pattern recognition, and machine learning, and includes analyzing user data and interpreting communications related to the orders, and wherein the orders whose information is identified include the one or more orders that specify the one or more services ordered by the user.

17. The computer program product of claim 15, wherein the operations further comprise:
receiving from the user an indication of consent to an extraction of data from applications being executed on a device of the user and which include data about purchases made by the user; and
in response to the received consent, extracting the data about purchases from the applications by using application programming interfaces (APIs) that interact with the applications, wherein the identifying which of the orders are the active orders, the pending orders, or the past orders is based on the extracted data.

18. The computer program product of claim 15, wherein the operations further comprise:
receiving a selection made by the user of a cancellation selection that cancels an order, wherein the cancellation selection is included in the one or more cancellation selections presented in the user interface, and wherein the order is included in the one or more orders; and
in response to the receiving the selection, canceling the order by performing a secure access to information about the order using an integrated authentication process and a secure execution protocol, wherein the secure access includes interfacing with a third-party service database, and wherein the canceling includes maintaining privacy and data protection standards.

19. The computer program product of claim 15, wherein the operations further comprise:
identifying the one or more orders by determining that the one or more services specified by the one or more orders have one or more level of activity, respectively, wherein each level of activity is less than a threshold level of activity based on a machine learning (ML) model analyzing one or more patterns of usage and frequencies of usage of the one or more services by the user;
presenting in the user interface the one or more cancellation selections as one or more recommendations to the user for canceling the one or more orders, respectively, the one or more recommendations being based on each of the one or more levels of activity of the one or more services being less than the threshold level of activity;
receiving, via the user interface, a correction or a confirmation made by the user of a recommendation included in the one or more recommendations;
refining the ML model by using a user feedback loop that employs reinforcement learning based on the correction or the confirmation; and
based on the refined ML model, generating and presenting improved recommendations to the user for canceling subsequent orders.

20. The computer program product of claim 19, wherein the identifying the one or more orders includes evaluating one or more behaviors of the user to determine a likelihood of a given order being intentionally active or inadvertently retained by the user by assessing usage patterns and a frequency of usage for the given order by using a decision tree classifier.
